(19) United States
(12) Patent Application Publication
(10) Pub. No.: US 2019/0251453 A1
(43) Pub. Date: Aug. 15, 2019

(54) METHOD AND SYSTEM FOR DETERMINING OCCURRENCE OF SEWER FLOODING IN A GEOGRAPHICAL AREA

(71) Applicant: WIPRO LIMITED, BANGALORE (IN)

(72) Inventor: Nagaraj Kanniganti, HYDERABAD (IN)

(73) Assignee: Wipro Limited

(21) Appl. No.: 15/941,011

(22) Filed: Mar. 30, 2018

(30) Foreign Application Priority Data
Feb. 15, 2018 (IN) 201841005877

(51) Int. Cl. G06N 5/04; G06N 99/00

(52) U.S. Cl. CPC G06N 5/04; E03F 5/00; G06N 99/005

(57) ABSTRACT

Embodiments of present disclosure discloses method and system for determining occurrence of sewer flooding in a geographical area. Initially, one or more attributes associated with geographical area are retrieved. The one or more attributes comprises historic data associated with sewer network in geographical area, one or more characteristics of sewer network, weather parameters relating to geographical area, blockage data and complaint data associated with sewage network. One or more sewer flooding factors influencing occurrence of sewer flooding in geographical area are generated based on one or more attributes. Upon generation, one or more predictor variables from one or more sewer flooding factors are identified based on scores generated for each of one or more sewer flooding factors using scoring technique. The one or more predictor variables are provided to prediction model which is trained based on historic data associated with sewer network and one or more characteristics of sewer network.

### TECHNICAL FIELD

The present subject matter is related in general to sewer management systems, more particularly, but not exclusively to a system and method for determining occurrence of sewer flooding in a geographical area.

### BACKGROUND

Sewage network is an infrastructure comprising pipelines arranged to carry sewage for a particular geographical area. Usually, the sewage network may be an underground system and regular monitoring and maintenance is essential for avoiding flooding of the sewage. During long periods of rainfall, if the sewer network is not properly built or in case of blockages in pipes of the sewer network, the sewer may start to overflow causing flooding. Blockage in the sewer network, may be due to fats, oil, grease, root growth and non-flushable objects such as wet wipes, sanitary objects and so on. Also, the sewer network may be directly impacted by other factors within the sewer network such as pipe material, water type or products put into wastewater supply by customers, which may also cause various types of blockages within the sewer network. Such occurrence of sewer flooding incidents and subsequent management may be a major nuisance from an environmental, operational and customer dissatisfaction perspectives.

One or more techniques are implemented to predict and assess such flooding occurrences. Some techniques include to provide a flooding risk assessment score and a flood warning system based on satellite imagery and cartographical methods. Other techniques include to determine futuristic rainfall forecasts in catchment areas for issuing alerts on risk and severity of expected flooding in the catchment areas. Other techniques may include to perform analysis of inflow and outflow of rain water by simulation studies of rain water through the sewer network for the prediction. However, such techniques are implemented to provide raw data for assessment and prediction of the flooding occurrences. The predicted results may not be accurate in these techniques.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for determining occurrence of sewer flooding in a geographical area. For the determination, initially, one or more attributes associated with a geographical area are retrieved. The one or more attributes comprises historic data associated with a sewer network in the geographical area, one or more characteristics of the sewer network, weather parameters relating to the geographical area, blockage data and complaint data associated with the sewage network. One or more sewer flooding factors influencing occurrence of sewer flooding in the geographical area are generated based on the one or more attributes. Upon the generation, one or more predictor variables from the one or more sewer flooding factors are identified based on scores generated for each of the one or more sewer flooding factors using a scoring technique. The one or more predictor variables are provided to a prediction model which is trained based on the historic data associated with the sewer network and the one or more characteristics of the sewer network.

In an embodiment, the present disclosure relates to an occurrence determination system for determining occurrence of sewer flooding in a geographical area. The occurrence determination system comprises a processor and a memory communicatively coupled to the processor. Initially, one or more attributes associated with a geographical area are retrieved. The one or more attributes comprises historic data associated with a sewer network in the geographical area, one or more characteristics of the sewer network, weather parameters relating to the geographical area, blockage data and complaint data associated with the sewage network. One or more sewer flooding factors influencing occurrence of sewer flooding in the geographical area are generated based on the one or more attributes. Upon the generation, one or more predictor variables from the one or more sewer flooding factors are identified based on scores generated for each of the one or more sewer flooding factors using a scoring technique. The one or more predictor variables are provided to a prediction model which is trained based on the historic data associated with the sewer network and the one or more characteristics of the sewer network.

In an embodiment, a non-transitory computer readable medium including instructions stored thereon that when processed by at least one processor cause a device to perform operations for determining occurrence of sewer flooding in a geographical area. Initially, one or more attributes associated with a geographical area are retrieved. The one or more attributes comprises historic data associated with a sewer network in the geographical area, one or more characteristics of the sewer network, weather parameters relating to the geographical area, blockage data and complaint data associated with the sewage network. One or more sewer flooding factors influencing occurrence of sewer flooding in the geographical area are generated based on the one or more attributes. Upon the generation, one or more predictor variables from the one or more sewer flooding factors are identified based on scores generated for each of the one or more sewer flooding factors using a scoring technique. The one or more predictor variables are provided to a prediction model which is trained based on the historic data associated with the sewer network and the one or more characteristics of the sewer network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIGS. 1a and 1b illustrate exemplary environments for determining occurrence of sewer flooding, in a geographical area in accordance with some embodiments of the present disclosure;

FIG. 2 shows a detailed block diagram of an occurrence determination system for determining occurrence of sewer flooding in a geographical area, in accordance with some embodiments of the present disclosure;

FIG. 3 illustrates a flowchart showing an exemplary method for determining occurrence of sewer flooding in a geographical area, in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure provides an efficient and accurate system and method for determining occurrence of sewer flooding in a geographical area. One or more attributes, retrieved for determining the occurrence, undergo data mining to generate one or more sewer flooding factors. From the one or more sewer flooding factors, one or more predictor variables are selected. The selected one or more predictor variables are provided to a prediction model for determining the occurrence of the sewer flooding in the geographical area. The present disclosure provides an Artificial Neural Networks (ANN) based prediction of the occurrence of the sewer flooding, by which accurate predictions are outputted.

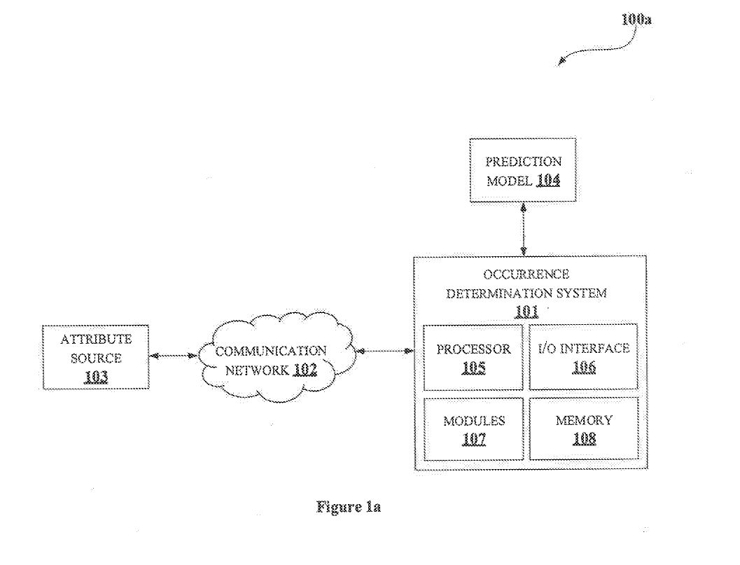

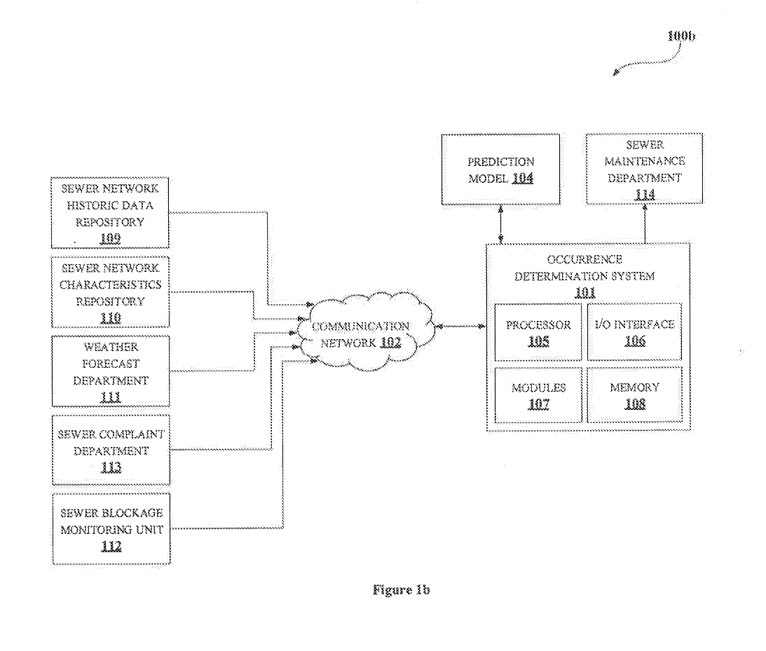

FIGS. 1a and 1b illustrate exemplary environments 100a and 100b of an occurrence determination system 101 for determining occurrence of sewer flooding in a geographical area. The exemplary environment 100a comprises the occurrence determination system 101, a communication network 102, an attribute source 103 and a prediction model 104, to determine the occurrence of the sewer flooding. The occurrence determination system 101 may be configured to determine the occurrence of the sewer flooding in the geographical area, as disclosed in the present disclosure. The occurrence determination system 101 may communicate with the attribute source 103 via the communication network 102 as shown in the figure. One or more attributes for determining the occurrence of the sewer flooding may be retrieved from the attribute source 103, by the occurrence determination system 101 via the communication network 102. Further, the prediction model 104 may be a trained model configured to determine the occurrence based on data provided by the occurrence determination system 101. In an embodiment, the occurrence determination system 101 may communicate with the prediction model 104 via the communication network 102 (not shown in the figure). In an embodiment, the prediction model 104 may be integrated within the occurrence determination system 101. In an embodiment, the communication network 102 may include, without limitation, a direct interconnection, Local Area Network (LAN), Wide Area Network (WAN), wireless network (e.g., using Wireless Application Protocol), the Internet, and the like.

Further, the occurrence determination system 101 may include a processor 105, an I/O interface 106, one or more modules 107 and a memory 108. In some embodiments, the memory 108 may be communicatively coupled to the processor 105. The memory 108 stores processor executable instructions, which, on execution, may cause the occurrence determination system 101 to determine the occurrence of the sewer flooding, as disclosed in the present disclosure. The occurrence determination system 101 may be implemented in a variety of computing systems, such as a laptop computer, a desktop computer, a Personal Computer (PC), a notebook, a smartphone, a tablet, e-book readers, a server, a network server, and the like.

For the determining the occurrence of the sewer flooding, initially, the one or more attributes associated with the geographical area may be retrieved from the attribute source 103. The one or more attributes may include, but are not limited to, historic data associated with a sewer network in the geographical area, one or more characteristics of the sewer network, weather parameters relating to the geographical area, blockage data and complaint data associated with the sewage network. Each of the one or more attributes may be retrieved from respective source and stored in the attribute source 103 for determining the occurrence of the sewer flooding. In an embodiment, as shown in FIG. 1b, the occurrence determination system 101 in the environment 100b may be configured to communicate with source of each of the one or more attributes, dynamically, for determining the occurrence of the sewer flooding. In an embodiment, the historic data associated with the sewer network may be retrieved from the sewer network historic data repository 109. In an embodiment, the historic data may include previous flooding incidents associated with the sewer network. In an embodiment, the one or more characteristics of the sewer network may be retrieved from a sewer network characteristics repository 110. The one or more characteristics may include, but are not limited to, flood interceptor removed status, flood resrelbus closure status, manhole located status, location trap, turning chamber, removal type, interceptor trap and so on. In an embodiment, the weather parameters may be retrieved from the weather forecast department 111 associated with the geographical area. The weather parameters may include rainfall status in the geographical area. In an embodiment, the blockage data may be retrieved from the sewer blockage monitoring unit 112. The sewer blockage monitoring unit 112 may be configured to monitor blockages in the sewer network and provide location and cause of blockages i.e., the blockage data, to the occurrence determination system 101. In an embodiment, the complaint data may include complaints associated with the sewage network in the geographical area. The complaint data may be retrieved from the sewer complaint department 113 which may be operated to receive complaints on the sewer network from residents of the geographical area or people who are affected by the sewer network. In an embodiment, the attribute source 103 may be configured to retrieve the one or more attributes from the respective source dynamically and the occurrence determination system 101 may be configured to retrieve the one or more attributes from the attribute source 103 (not shown in figure).

Upon retrieving the one or more attributes, one or more sewer flooding factors influencing occurrence of the sewer flooding may be generated based on the one or more attributes. In an embodiment, a data mining technique may be implemented on the one or more attributes for generating the one or more sewer flooding factors. In an embodiment, the one or more sewer flooding factors may be factors that influence the sewer flooding in the geographical area. In an embodiment, the one or more sewer flooding factors may be associated with the sewer network.

Upon generating the one or more sewer flooding factors, one or more predictor variables from the one or more sewer flooding factors may be identified based on scores for each of the one or more sewer flooding factors. The scores for each of the one or more sewer flooding factors may be generated using a scoring technique. In an embodiment, the one or more predictor variables may be most critical factors that may influence the sewer flooding in the geographical area. The one or more predictors variables may be identified by one or more techniques known to a person skilled in the art, using the generated scores.

Upon identifying the one or more predictor variables, the occurrence determination system 101 may be configured to provide the one or more predictor variables to the prediction model 104 for determining the occurrence of the sewer flooding. In an embodiment, the prediction model 104 may be trained based on the historic data associated with the sewer network and the one or more characteristics of the sewer network. The determined occurrences may be based on weights generated for each of the one or more predictor variables in correspondence with each of one or more predefined outputs of the prediction model 104.

In an embodiment of the present disclosure, the occurrence determination system 101 may be further configured to generate a geo-spatial map for the geographical area based on the predicted probability of occurrence of the sewer flooding. In an embodiment, the geo-spatial map may be generated to indicate visual representation of determined occurrences of the sewer flooding.

In an embodiment, the occurrence determination system 101 may be configured to provide output to a sewer maintenance department 114 as shown in FIG. 1b. The output may be at least one of the determined occurrence of the sewer flooding and the generated geo-spatial map. In an embodiment, the output may be provided to a dashboard for displaying the geo-spatial map, indicating the occurrence of the sewer flooding. The output may be provided to the sewer maintenance department 114 for taking necessary action to avoid the occurrences of the sewer flooding.

In an embodiment, the occurrence determination system 101 may receive data for determining occurrences of the sewer flooding through the I/O interface 106 of the occurrence determination system 101. The received data may include, but is not limited to, at least one of the one or more attributes, data from the prediction model 104 and so on. Also, the occurrence determination system 101 may transmit data to the predictor model 104, for determining occurrences of the sewer flooding, via the I/O interface 106. The transmitted data may include, but is not limited to, at least one of the one or more sewer flooding factors, one or more predictor variables, the determined occurrences, the geo-spatial maps and so on. The I/O interface 106 may be coupled with the processor 105 of the occurrence determination system 101.

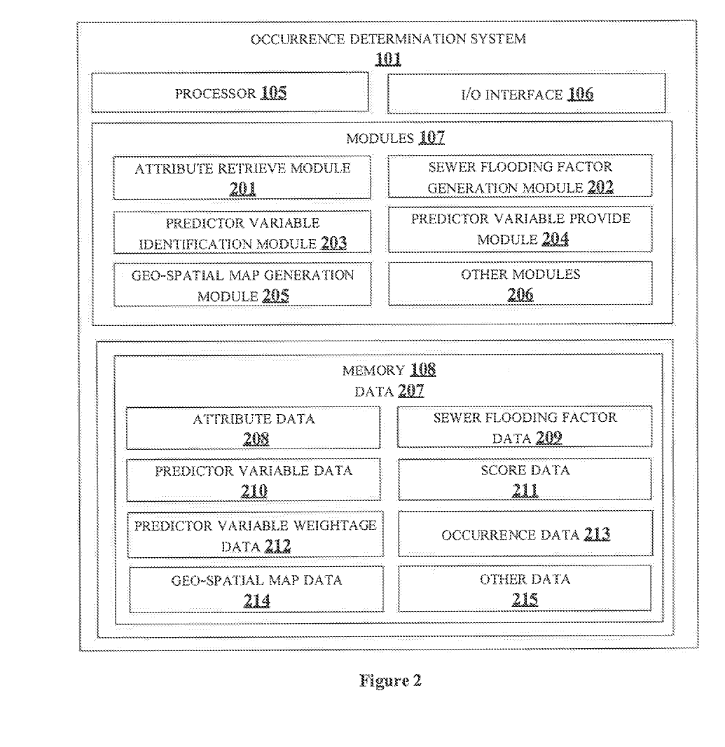

FIG. 2 shows a detailed block diagram of the occurrence determination system 101 for determining occurrence of the sewer flooding in accordance with some embodiments of the present disclosure.

The data 207 in the memory 108 and the one or more modules 107 of the occurrence determination system 101 may be described herein in detail.

In one implementation, the one or more modules 107 may include, but are not limited to, an attribute retrieve module 201, a sewer flooding factor generation module 202, a predictor variable identification module 203, a predictor variable provide module 204, a geo-spatial generation module 205, and one or more other modules 206, associated with the occurrence determination system 101.

In an embodiment, the data 207 in the memory 108 may comprise attribute data 208 (also referred to as one or more attributes 208), sewer flooding factor data 209 (also referred to as one or more sewer flooding factors 209), predictor variable data 210 (also referred to as one or more predictor variables 210), score data 211 (also referred to as score 211), predictor variable weightage data 212 (also referred to as weights 212), occurrence data 213 (also referred to as occurrence of sewer flooding 213), geo-spatial map data 214 (also referred to as geo-spatial map 214) and other data 215 associated with the occurrence determination system 101.

In an embodiment, the data 207 in the memory 108 may be processed by the one or more modules 107 of the occurrence determination system 101. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. The one or more modules 107 when configured with the functionality defined in the present disclosure may result in a novel hardware.

For the determining occurrence of the sewer flooding 213, the one or more attributes 208 associated with the geographical area may be retrieved by the attribute retrieve module 201. The one or more attributes 208 may include, but are not limited to, the historic data associated with the sewer network in the geographical area, the one or more characteristics of the sewer network, the weather parameters relating to the geographical area, the blockage data and the complaint data associated with the sewage network. In an embodiment, the historic data may include previous output of the occurrence determination system 101. In an embodiment, the one or more characteristics may include, but are not limited to, flood interceptor removed status, flood resrelbus closure status, manhole located status, location trap, turning chamber, removal type, interceptor trap and so on. The flood resrelbus closure status provides flood protection relief valve associated with the sewer network. In a non-limiting embodiment, the one or more characteristics may include any feature associated with the sewer network, that may be used for determining the occurrence of the sewer flooding 213, by the occurrence determination system 101. The weather parameters may include rainfall status in the geographical area. The rainfall status may indicate if rainfall is heavy rainfall, mild rainfall and so on. In an embodiment, the weather parameter may be measure of rate of rainfall in the geographical area. The blockage data may include, but is not limited to, location and cause of blockages in the sewer network. For example, the blockage data may indicate that there is a blockage at a turning chamber in the sewer network and cause of blockage is growth of roots in the turning chamber. In an embodiment, the complaint data may include complaints associated with the sewage network in the geographical area.

Further, the sewer flooding factor generation module 202 may be configured to generate the one or more sewer flooding factors 209. The one or more sewer flooding factors 209 may be generated by implementing the data mining technique on the one or more attributes 208. The one or more sewer flooding factors 209 may be factors that influence the sewer flooding in the geographical area. Examples of the one or more sewer flooding factors 209, may include, but are not limited to, manhole located, flood postcode, connection type, location trap, turning chamber, flood cause of blockage, flood occurred, removal type, flood cde job, flood bl at interceptor, flood interceptor removed, flood resrelbus closure, interceptor trap, rainfall rate and so on. Said data mining technique may be a stipulated approach which aims in analysing real-world datasets i.e., the one or more attributes 208 in the present disclosure. In an embodiment, the data mining technique may be a machine learning model configured to predict most frequent data patterns influencing occurrence of the sewer flooding 213 in the geographical area. By the data mining technique, improved understanding of factors related to the sewer flooding may be achieved. In an embodiment, the Frequency-Patterns (FP) Growth machine learning may be implemented for generating the one or more sewer flooding factors 209 in form of frequency patterns. By using the data mining technique in the present disclosure, computational efficiency may be increased. One or more learning models, known to a person skilled in the art may be implemented for the data mining technique.

The predictor variable identification module 203 may be configured to identify the one or more predictor variables 210 from the one or more sewer flooding factors 209. The one or more predictor variables 210 may be identified based on the score 211 generated for each of the one or more sewer flooding factors 209. The score 211 for each of the one or more sewer flooding factors 209 may be generated using a scoring technique. In the scoring technique, probability factor associated with each of the one or more sewer flooding factors 209 may be computed for generating the score 211 for the corresponding sewer flooding factor. The probability factor of a sewer flooding factor may indicate probability of the occurrence of the sewer flooding 213 with influence of the sewer flooding factor. Any scoring technique, known to a person skilled in the art, may be implemented for computing the score 211 for each of the one or more sewer flooding factors 209. In an embodiment, the predictor variable identification module 203 may identify the one or more sewer flooding factors 209, associated with the score 211 greater than a predefined score value, to be the one or more predictor values 210. In an embodiment, the predictor variable identification module 203 may be configured to identify the one or more sewer flooding factors 209 with predefined number of high values to be the one or more predictor variables 210. For example, one or more sewer flooding factors 209 associated with top five highest values of the score 211 may be identified to be the one or more predictor variables 210. Similarly, in another embodiment, one or more sewer flooding factors 209 associated with top ten high values of the score 211 may be identified to be the one or more predictor variables 210. One or more techniques, known to a person skilled in the art may be implemented for identifying the one or more predictor variables 210 from the one or more sewer flooding factors 209, using the generated scores 211.

Further, the predictor variable provide module 204 may be configured to provide the identified one or more predictor variables 210 to the prediction model 104. In an embodiment, the prediction model 104 may be an Artificial Intelligence (AI) model which may be fed with the one or more predictor variables 210 to output an outcome variable which may be used to determine the occurrence of the sewer flooding 213. In the embodiment, the one or more predictor variables 210 may be referred to as independent variables, if the one or more predictor variables 210 are manipulated by the occurrence determination system 101, rather than measured. The prediction model 104 may be trained based on the historic data associated with the sewer network and the one or more characteristics of the sewer network. In an embodiment, the prediction model 104 may be trained such that the prediction model 104 automatically predicts the occurrences of the sewer flooding with the one or more predictor variables 210 as an input. In an embodiment, back propagation ANN may be used as prediction model 104, which may be an iterative based feedback system. The historic data used for training the prediction model 104 may include previous records of sewer flooding incidents. In an embodiment, along with the historic data, corresponding values of sewer blockages data, sewer networks characteristics and weather parameters may also be used for training the prediction model 104.

The determined occurrences may be based on the weights 212 generated for each of the one or more predictor variables 210 in correspondence with each of one or more predefined outputs of the prediction model 104. For example, consider the identified one or more predictor variables 210 from the one or more sewer flooding factors 209 are the flood resrelbus closure, the flood bl at interceptor, the interceptor trap, the location trap, the flood cause of blockage and the manhole located. The weights 212 generated to the one or more predictor variables 210 may be as indicated in below Table 1:

TABLE 1

| PREDICTOR VARIABLE | WEIGHT |
|---|---|
| flood resrelbus closure | ‘N’ |
| flood bl at interceptor | ‘ ’ |
| interceptor trap | ‘N’ |
| location trap | ‘Y’ |
| flood cause of blockage | ‘Y’ |
| manhole located | ‘Y’ |

In the above table, the weight ‘N’ may indicate that the predictor variable is not influencing occurrence of the sewer flooding 213, the weight ‘Y’ may indicate that the predictor variable is influencing occurrence of the sewer flooding 213 and the weight ‘ ’ may indicate that data associated with the predictor variable is not available. One or more techniques, known to person skilled in the art may be implemented for determining the weights 212 for the one or more predictor variables 210. From the above table, the prediction model 104 may be configured to predict the occurrence of the sewer flooding 213. In an embodiment, the prediction model 104 may be configured to compute probability of occurrence of the sewer flooding 213. The computed probability may be a value varying from ‘0’ to ‘1’. If the computed probability is ‘1’, the occurrence of the sewer flooding may be high. If the computed probability is ‘0’, there may be no occurrence of the sewer flooding 213. If the computed probability is ‘0.5’, there may be 50% chances for the occurrence of the sewer flooding 213. In an embodiment, the occurrence of the sewer flooding 213 may be indicated as one of ‘Y’ and ‘N’, where ‘Y’ indicates that the sewer flooding may occur and ‘N’ may indicate that the sewer flooding may not occur. In an embodiment, along with the determined occurrences, the one or more sewer flooding factors 209 which are actually influencing the sewer flooding may be provided.

The geo-spatial map generation module 205 may be configured to generate the geo-spatial map 214 for the geographical area based on the predicted probability of occurrence of the sewer flooding 213. In an embodiment, the geographical area of higher predicted probabilities of occurrence of the sewer flooding 213 may be plotted on geo-spatial map 214. In an embodiment, the geo-spatial map 214 may also indicate the one or more sewer flooding factors 209 influencing the sewer flooding.

In an embodiment, an interactive visual dashboard may be implemented along with the occurrence determination system 101 for providing inferences and insights into the historic data. The inferences may be provided through visual analytics and visual spot trending of the blockages and flooding data associated with the sewer network, through base map plotting. In an embodiment, the geo-spatial map 214 depicting locations of high probable predicted sewer flooding may be integrated with interactive Geographic Information System (GIS) maps to co-relate the sewer network with the predicted locations in the sewer network. In an embodiment, the occurrence determination system 101 may be integrated with existing geo-spatial map like google map, open street map and so on.

The other data 215 may store data, including temporary data and temporary files, generated by modules for performing the various functions of the occurrence determination system 101. The one or more modules 107 may also include other modules 206 to perform various miscellaneous functionalities of the occurrence determination system 101. It will be appreciated that such modules may be represented as a single module or a combination of different modules.

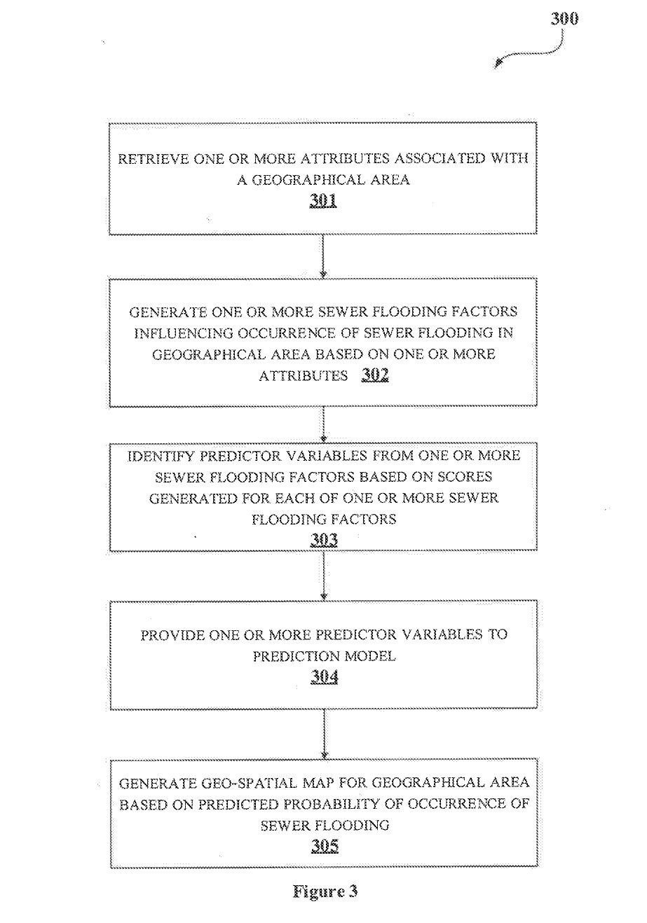

FIG. 3 illustrates a flowchart showing an exemplary method 300 for determining occurrence of the sewer flooding 213 in the geographical area, in accordance with some embodiments of present disclosure.

At block 301, the attribute retrieve module 201 may retrieve the one or more attributes 208 associated with the geographical area. The one or more attributes 208 may include, but are not limited to, the historic data associated with the sewer network in the geographical area, the one or more characteristics of the sewer network, the weather parameters relating to the geographical area, the blockage data and the complaint data associated with the sewage network.

At block 302, the sewer flooding factor generation module 202 may generate the one or more sewer flooding factors 209 influencing the occurrence of the sewer flooding 213 based on the one or more attributes 208. The data mining technique may be implemented on the one or more attributes 208 to generate the one or more sewer flooding factors 209.

At block 303, the predictor variable identification module 203 may identify the one or more predictor variables 210 based on the score 211 generated for each of the one or more sewer flooding factors 209. The score 211 for each of the one or more sewer flooding factors 209 may be generated based on the scoring technique.

At block 304, the predictor variable provide module 205 may provide the one or more predictor variables 210 to the prediction model 104. The prediction model 104 may be trained based on the historic data associated with the sewer network and the one or more characteristics of the sewer network, by inputting the one or more predictor variables 210, the prediction model 104 may be configured to output the occurrence of the sewer flooding 213.

At block 305, the geo-spatial map generation module 205 may generate the geo-spatial map for the geographical area. The geo-spatial map 214 may be generated based on the determined occurrence of the sewer flooding 213 in the geographical area.

As illustrated in FIG. 3, the method 300 may include one or more blocks for executing processes in the occurrence determination system 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

### Computing System

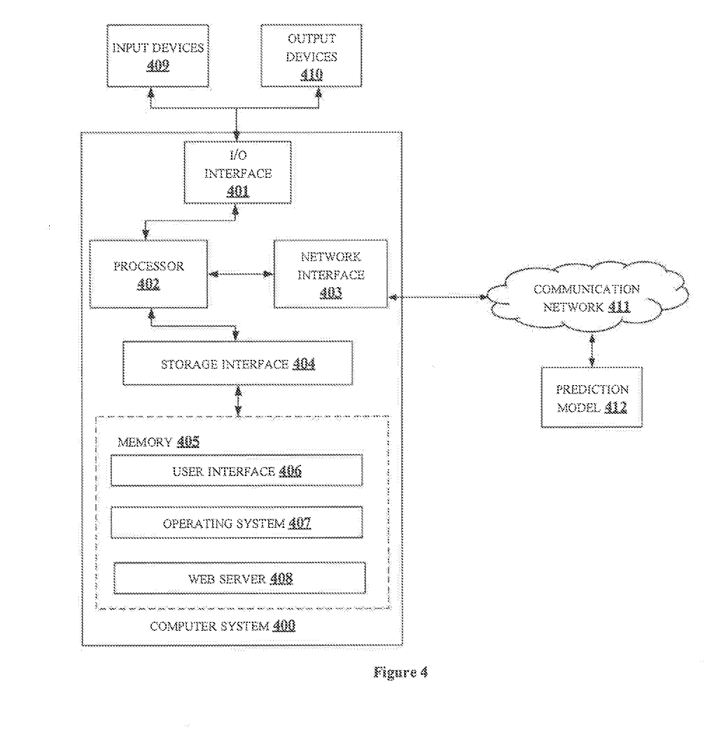

FIG. 4 illustrates a block diagram of an exemplary computer system 400 for implementing embodiments consistent with the present disclosure. In an embodiment, the computer system 400 is used to implement the occurrence determination system 101. The computer system 400 may include a central processing unit (“CPU” or “processor”) 402. The processor 402 may include at least one data processor for executing processes in Virtual Storage Area Network. The processor 402 may include specialized processing units such as, integrated system (bus) controllers, memory management control units, floating point units, graphics processing units, digital signal processing units, etc.

The processor 402 may be disposed in communication with one or more input/output (I/O) devices 409 and 410 via 1/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices 409 and 410. For example, the input devices 409 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 410 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 may consist of the occurrence determination system 101. The processor 402 may be disposed in communication with the communication network 411 via a network interface 403. The network interface 403 may communicate with the communication network 411. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 411 may include, without limitation, a direct interconnection, local area network (LAN), wide area network (WAN), wireless network (e.g., using Wireless Application Protocol), the Internet, etc. Using the network interface 403 and the communication network 411, the computer system 400 may communicate with the prediction model 412 for determining the occurrence of the sewer flooding. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 411 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407 etc. In some embodiments, computer system 400 may store user/application data 406, such as, the data, variables, records, etc., as described in this disclosure. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

### Advantages

An embodiment of the present disclosure provides a system and method for maintaining sewage network in a geographical area by determining occurrence of sewer flooding. By determining the occurrence of the sewer flooding, the incident of sewage flooding may be avoided if necessary actions and remedies are taken based on the determined occurrences.

An embodiment of the present disclosure provides a data driven model for determining occurrence of sewer flooding. Raw data is mined for understanding influencing factors. Hence, the present disclosure works well with limited variables and predicts occurrence of sewer flooding, accurately.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100a and 100b | Environment |
| 101 | Occurrence determination system |
| 102 | Communication network |
| 103 | Attribute source |
| 104 | Prediction model |
| 105 | Processor |
| 106 | I/O interface |
| 107 | Modules |
| 108 | Memory |
| 109 | Sewer network historic data repository |
| 110 | Sewer network characteristics repository |
| 111 | Weather forecast department |
| 112 | Sewer blockage monitoring unit |
| 113 | Sewer complaint department |
| 114 | Sewer maintenance department |
| 201 | Attribute retrieve module |
| 202 | Sewer flooding factor generation module |
| 203 | Predictor variable identification module |
| 204 | Predictor variable provide module |
| 205 | Geo-spatial map generation module |
| 206 | Other modules |
| 207 | Data |
| 208 | Attribute data |
| 209 | Sewer flooding factor data |
| 210 | Predictor variable data |
| 211 | Score data |
| 212 | Predictor variable weightage data |
| 213 | Occurrence data |
| 214 | Geo-spatial map data |
| 215 | Other data |
| 400 | Computer System |
| 401 | I/O Interface |
| 402 | Processor |
| 403 | Network Interface |
| 404 | Storage Interface |
| 405 | Memory |
| 406 | User interface |
| 407 | Operating System |
| 408 | Web Server |
| 409 | Input Devices |
| 410 | Output Devices |
| 411 | Communication Network |
| 412 | Prediction model |

We claim:

1. A method for determining occurrence of sewer flooding in a geographical area, comprising:
retrieving, by an occurrence determination system (101), one or more attributes (208) associated with a geographical area, wherein the one or more attributes (208) comprises historic data associated with a sewer network in the geographical area, one or more characteristics of the sewer network, weather parameters relating to the geographical area, blockage data and complaint data associated with the sewage network;
generating, by the occurrence determination system (101), one or more sewer flooding factors (209) influencing occurrence of sewer flooding in the geographical area, based on the one or more attributes (208);
identifying, by the occurrence determination system (101), one or more predictor variables (210) from the one or more sewer flooding factors (209) based on score (211) generated for each of the one or more sewer flooding factors (209) using a scoring technique; and
providing, by the occurrence determination system (101), the one or more predictor variables (210) to a prediction model (104) trained based on the historic data associated with the sewer network and the one or more characteristics of the sewer network, for determining occurrence of the sewer flooding (213) in the geographical area.

2. The method as claimed in claim 1 further comprising, generating a geo-spatial map (214) for the geographical area based on the determined occurrence of the sewer flooding (213).

3. The method as claimed in claim 1, wherein the historic data comprises previous flooding incidents associated with the sewer network.

4. The method as claimed in claim 1, wherein the one or more characteristics of the sewer network comprises flood interceptor removed status, flood resrelbus closure status, manhole located status, location trap, turning chamber, removal type and interceptor trap.

5. The method as claimed in claim 1, wherein the one or more sewer flooding factors (209) are generated by using data mining technique on the one or more attributes (208).

6. The method as claimed in claim 1, wherein determining the occurrence is based on weights (212) generated for each of the one or more predictor variables (210) in correspondence with each of one or more predefined outputs of the prediction model (104).

7. An occurrence determination system (101) for determining occurrence of sewer flooding in a geographical area, comprises:
a processor (105); and
a memory (108) communicatively coupled to the processor (105), wherein the memory (108) stores processor-executable instructions, which, on execution, cause the processor (105) to:
retrieve one or more attributes (208) associated with a geographical area, wherein the one or more attributes (208) comprises historic data associated with a sewer network in the geographical area, one or more characteristics of the sewer network, weather parameters relating to the geographical area, blockage data and complaint data associated with the sewage network;
generate one or more sewer flooding factors (209) influencing occurrence of sewer flooding in the geographical area, based on the one or more attributes (208);
identify one or more predictor variables (210) from the one or more sewer flooding factors (209) based on score (211) generated for each of the one or more sewer flooding factors (209) using a scoring technique; and
provide the one or more predictor variables (210) to a prediction model (104) trained based on the historic data associated with the sewer network and the one or more characteristics of the sewer network, for determining occurrence of the sewer flooding (213) in the geographical area.

8. The occurrence determination system as claimed in claim 7 further comprises the processor (105) configured to generate a geo-spatial map (214) for the geographical area based on the determined occurrence of the sewer flooding (213).

9. The occurrence determination system as claimed in claim 7, wherein the historic data comprises previous flooding incidents associated with the sewer network.

10. The occurrence determination system as claimed in claim 7, wherein the one or more characteristics of the sewer network comprises flood interceptor removed status, flood resrelbus closure status, manhole located status, location trap, turning chamber, removal type and interceptor trap.

11. The occurrence determination system as claimed in claim 7, wherein the one or more sewer flooding factors are generated by using data mining technique on the one or more attributes (208).

12. The occurrence determination system as claimed in claim 7, wherein the occurrence is determined based on weights (212) generated for each of the one or more predictor variables (210) in correspondence with each of one or more predefined outputs of the prediction model (104).

13. A non-transitory computer readable medium including instructions stored thereon that when processed by at least one processor cause a device to perform operations comprising:
retrieve one or more attributes (208) associated with a geographical area, wherein the one or more attributes (208) comprises historic data associated with a sewer network in the geographical area, one or more characteristics of the sewer network, weather parameters relating to the geographical area, blockage data and complaint data associated with the sewage network;
generate one or more sewer flooding factors (209) influencing occurrence of sewer flooding in the geographical area, based on the one or more attributes (208);
identify one or more predictor variables (210) from the one or more sewer flooding factors (209) based on score (211) generated for each of the one or more sewer flooding factors (209) using a scoring technique; and
provide the one or more predictor variables (210) to a prediction model (104) trained based on the historic data associated with the sewer network and the one or more characteristics of the sewer network, for determining occurrence of the sewer flooding (213) in the geographical area.

14. The medium as claimed in claim 13 further comprises generating a geo-spatial map (214) for the geographical area based on the determined occurrence of the sewer flooding (213).

15. The medium as claimed in claim 13, wherein the historic data comprises previous flooding incidents associated with the sewer network.

16. The medium as claimed in claim 13, wherein the one or more characteristics of the sewer network comprises flood interceptor removed status, flood resrelbus closure status, manhole located status, location trap, turning chamber, removal type and interceptor trap.

17. The medium as claimed in claim 13, wherein the one or more sewer flooding factors (209) are generated by using data mining technique on the one or more attributes (208).

18. The medium as claimed in claim 13, wherein determining the occurrence is based on weights (212) generated for each of the one or more predictor variables (210) in correspondence with each of one or more predefined outputs of the prediction model (104).
